(19) United States
(12) Patent Application Publication
(10) Pub. No.: US 2007/0294990 A1
(43) Pub. Date: Dec. 27, 2007

(54) Locking harvester header lift cylinder

(75) Inventors: Bruce Alan Coers, Hillsdale, IL (US); Paul David Marvin, DeWitt, IA (US); Klaus Ernst Becker, East Moline, IL (US); Daniel James Burke, Cordova, IL (US); Jerry Alan Sandau, Orion, IL (US); Dohn William Pfeiffer, Davenport, IA (US)

Correspondence Address: DEERE & COMPANY, ONE JOHN DEERE PLACE, MOLINE, IL, 61265, US

(73) Assignee: Deere & Company, a Delaware corporation.

(21) Appl. No.: 11/474,702

(22) Filed: Jun. 26, 2006

(51) Int. Cl. A01D 41/14

(52) U.S. Cl. 56/10.2 E

(57) ABSTRACT

A feeder house of an agricultural harvester has lift cylinders that can be locked to reduce the risk of damage due to feeder house twisting due to impacts with the ground.

### FIELD OF THE INVENTION

The invention relates to agricultural harvesters. More particularly, it relates to headers for harvesters. Even more particularly, it relates to lift cylinders for such headers.

### BACKGROUND OF THE INVENTION

Headers on agricultural harvesters gather and cut the crops that are harvested. A typical header is an elongate laterally extending structure, typically 15-40 feet wide, that is supported on a feeder house located on the front of the harvester vehicle. The header is vertically moveable using hydraulic cylinders that are coupled to the feeder house at their forward ends and to the chassis of the harvester vehicle at their rear ends. The operator selectively raises and lowers the feeder house and the header attached thereto by adjusting the length of the hydraulic cylinders.

The hydraulic cylinders are not double acting--they do not include hydraulic circuits to actively retract the cylinders and lower the header. Instead, they rely on the weight of the header to do that. They include hydraulic circuits that fill the head end of the cylinder to extend it. When hydraulic fluid is released from the head end of the cylinders, the weight of the header and feeder house are sufficient to retract the cylinders.

For improved efficiency, agricultural equipment manufacturers have been making headers longer and longer. Each increase in length correspondingly increases the mass of the header. The increased length also increases the torque applied to the feeder house when the ends of the (now longer) header strike the ground.

As a result of this, the feeder house is subject to higher torques about a longitudinal axis that may damage the feeder house. It is an object of this invention to reduce the possibility of this damage by providing an apparatus to resist the torques applied to the feeder house due to end loads applied to the header.

### SUMMARY OF THE INVENTION

In accordance with a first aspect of the invention, a feeder house lift cylinder system is provided comprising at least one feeder house lift cylinder coupled to a hydraulic circuit that limits the extension of the cylinder from forces applied at the end of the header that is coupled to the feeder house.

### BRIEF DESCRIPTION OF THE DRAWINGS

FIG. 1 is a side view of an agricultural harvester showing a fragmentary left side feeder house hydraulic lift cylinder.

FIG. 2 is a rear perspective view of the feeder house and feeder house lift cylinders of FIG. 1 with the vehicle portion of the harvester removed for convenience of illustration.

FIG. 3 is a schematic diagram of the hydraulic circuit coupled to the cylinders of FIGS. 1 and 2.

### DESCRIPTION OF THE PREFERRED EMBODIMENT

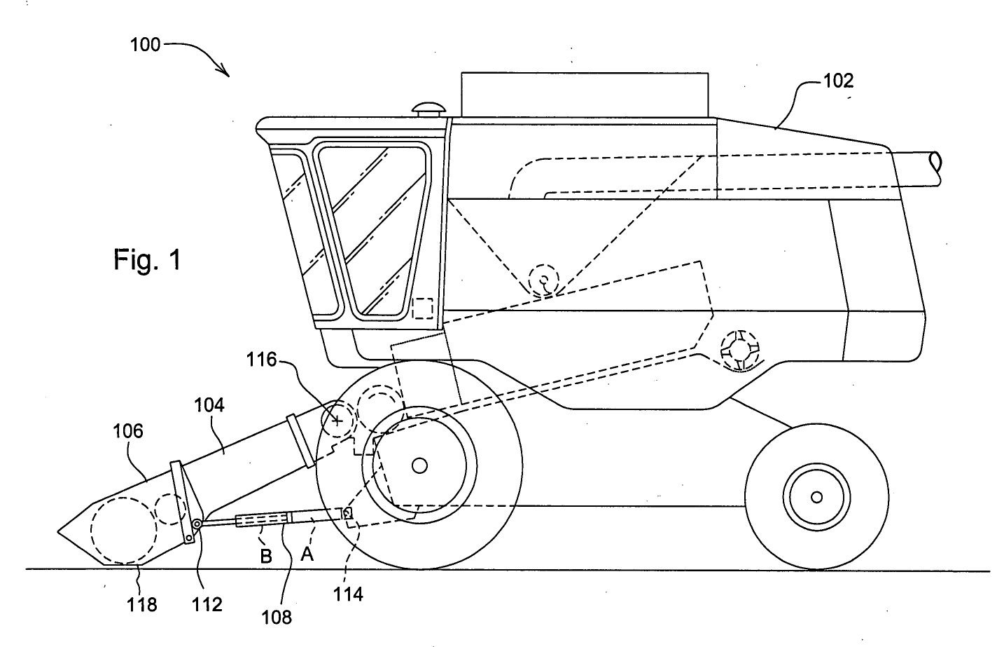

Referring now to FIG. 1, an agricultural harvester 100 is shown, comprising a self propelled vehicle portion 102 to which a feeder house 104 is pivotally coupled. The feeder house 104 supports a header 106 which is configured to gather and cut the crop. The feeder house 104 receives material from the header 106 and conveys it to the vehicle portion 102 for threshing, separation, cleaning, and storage.

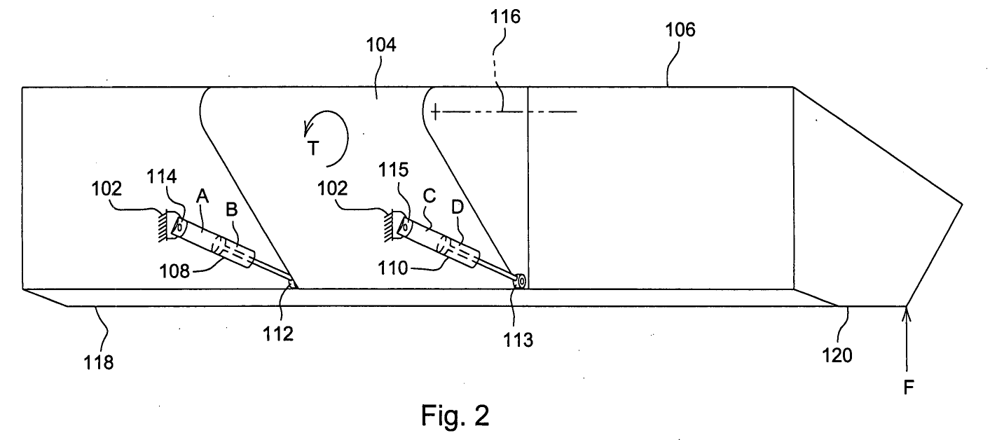

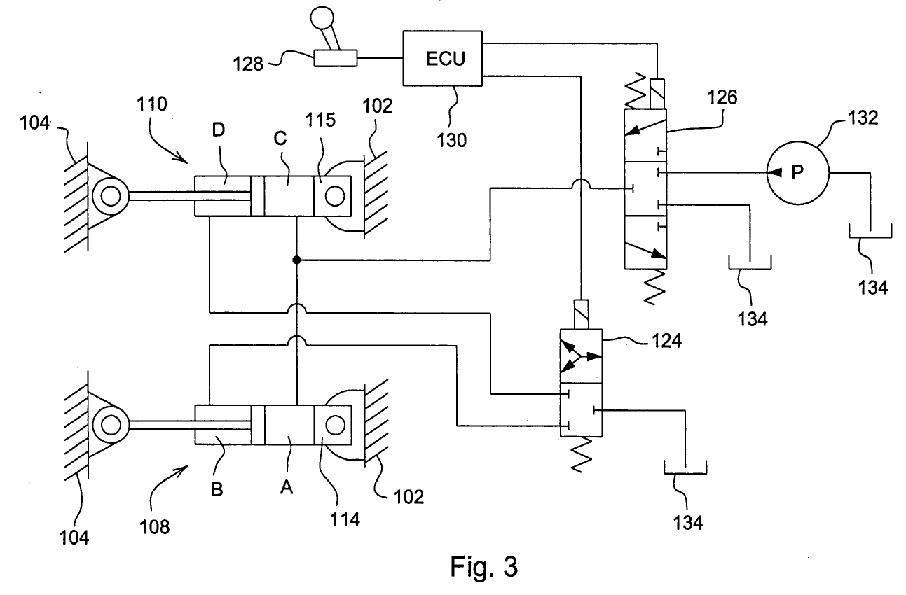

Two hydraulic lift cylinders 108, 110 (FIGS. 2 and 3) are coupled to and between the feeder house 104 and the vehicle portion 102 to lift and lower the front end of the feeder house 104 with respect to the vehicle portion 102. This lifting and lowering raises and lowers the header 106 with respect to the vehicle portion 102 and the ground because the header 106 is supported on the front end of the feeder house 104.

The forward ends 112, 113 of the left lift cylinder 108 and right lift cylinder 110, respectively, (only cylinder 108 is shown in FIG. 1) are pivotally coupled to a lower forward portion of the feeder house 104. The rear ends 114, 115, of the lift cylinders 108, 110, respectively, are pivotally coupled to the vehicle portion 102.

The feeder house itself is pivotally coupled to the vehicle portion to pivot up and down. It pivots about an axis 116 that extends laterally with respect to the vehicle and its direction of travel through the agricultural field.

The feeder house 104 is a rigid structure that holds the header in a horizontal orientation. It prevents the header 106 from twisting about a longitudinal axis and dipping the left and right ends of the header into the earth.

Referring now to FIG. 2, the feeder house supports the header at the midpoint of the header 106, equidistant from the left end 118 and the right end 120 of the header 106. The two lift cylinders 108,110 are coupled to the feeder house 104 near the front bottom left and front bottom right corners of the feeder house 104. The cylinders themselves are oriented in parallel and are spaced apart from each other on opposite sides of the feeder house.

As headers are manufactured wider and wider, impacts at the corners of the headers (shown schematically as an upward force arrow “F” in FIG. 2) apply greater torques “T” (FIG. 2) about a longitudinal axis to the front end of the feeder house. The rear of the feeder house is constrained to pivot about lateral axis 116. With the rear of the feeder house prevented from twisting about a longitudinal axis and the front of the feeder house twisted about a longitudinal axis, there is a greater risk of feeder house damage. Twisting caused by (for example) the force “F” will raise the right side of the feeder house, tending to extend right side cylinder 110, which would increase cylinder volume “C” of the head end of the cylinder and decrease volume “D” (FIG. 2) of the rod end of the cylinder. If the rod end of cylinder 110 was in free fluid communication with a hydraulic tank or reservoir (as prior art lift cylinders are), cylinder 110 would provide very limited resistance to this twisting. On the other hand, if fluid flow from the rod end of cylinder 110 is blocked, cylinder 110 will act like a rigid member and will help resist the upward movement of the right side of the feeder house and twisting of the feeder house. Similarly, if flow from the rod end of cylinder 108 is also blocked, cylinder 108 will also act like a rigid member and resist twisting of the feeder house in the opposite direction of torque “T” by ground impact forces applied to the left end of the header 106.

This blocking of fluid flow from the cylinders is provided by the present invention, and particularly by the hydraulic circuit illustrated in FIG. 3. Referring now to FIG. 3, left and right feeder house lift cylinders 108,110 are coupled to a hydraulic circuit 122 that raises and lowers the feeder house under operator command, and blocks flow from the cylinders 108,110 when the ends of the header impact the ground and tend to twist the feeder house.

In the preferred embodiment a first valve element 124 of circuit 122 opens to permit flow into and out of the rod ends of the cylinders whenever the operator commands a second valve element 126 to extend or retract the cylinders (i.e. to raise or lower the feeder house).

When the operator ceases commanding the cylinders to extend or retract, the first valve element blocks all flow of hydraulic fluid to and from the rod end of the cylinder. When fluid flow is prevented from exiting the cylinder both from the rod ends and the head ends, the cylinders function as a rigid member, and resist the twisting of the feeder house.

To raise the feeder house, the operator manipulates operator input device 128, which is coupled to electronic control unit (ECU) 130. ECU 130 responsively drives the first valve element 124 to move from its de-energized position (illustrated in FIG. 3) in which flow to and from the rod ends of cylinders 108,110 is blocked, to its second position in which flow is permitted. Valve element 126 sends hydraulic fluid under pressure from pump 132 to cylinders 108 to extend the cylinders. The force of gravity acting on the header and feeder house is employed to retract the cylinders. ECU 130 also drives the second valve element 126 to move from it de-energized position (illustrated in FIG. 3) to either of its two other positions, depending upon the position to which the operator has moved the operator input device 128. In one of these positions the second valve element 126 extends the cylinders and lifts the feeder house. In the other of these two positions, the second valve element retracts the cylinders and lowers the feeder house. ECU 130 is preferably a digital microcontroller. Operator input device 128 is preferably a quadrant lever coupled to a potentiometer or a shaft encoder that in turn is coupled to the ECU.

Once the feeder house is in the desired position, the operator releases the operator input device, which returns to a center neutral position. ECU 130 responsively returns the valve elements 124,126 to their de-energized positions illustrated in FIG. 3 for normal operation harvesting crop. In these valve positions, the cylinders can neither retract nor extend when either end of the header impacts the ground, thus counteracting torque “T” which tends to cause feeder house twisting.

Having described the preferred embodiment, it will become apparent that various modifications can be made without departing from the scope of the invention as defined in the accompanying claims. For example, the hydraulic cylinders can be mounted such that they lift the feeder house when they are retracted, in which case the hydraulic circuit connections to the hydraulic cylinders would be reversed to block flow out of the head ends of the cylinders during normal operation instead of blocking flow out of the rod ends. The first valve element 124 could permit flow into the rod end ports and prevent flow out of the cylinder rod end ports instead of preventing flow both ways. The separate valve elements could be combined in a single valve element or subdivided into multiple additional valve elements. The ECU could be partially or totally replaced with pneumatic or hydraulic components. The lifting and lowering of the feeder house may be automatically controlled by a program within the ECU in response to certain physical conditions instead of being manually controlled. The feeder house can be configured to permit the header to move up and down or rotate partially or totally about other axes of movement such as the horizontal and longitudinally extending axis about which torque “T” is generated. The feeder house need not be constrained to pivot about axis 116 but may have additional structures coupling it to the vehicle that give it a greater range of motion.

1. An agricultural harvester comprising:
a self-propelled vehicle;
a feeder house coupled to the vehicle to pivot about a lateral axis;
left and right feeder house lift cylinders coupled to and between the feeder house and the vehicle to lift and lower the feeder house with respect to the vehicle;
a hydraulic circuit coupled to the lift cylinders to block fluid flow from the cylinders during normal harvesting operation or machine transport thereby reducing twisting of the feeder house.

2. The harvester of claim 1, wherein the hydraulic circuit includes at least one valve element that alternatively (1) couples a first cylinder port of the cylinders to a hydraulic reservoir, and (2) blocks flow out of the first cylinder port.

3. The harvester of claim 2, wherein the cylinder port is a rod end cylinder port.

4. The harvester of claim 1, wherein the hydraulic circuit is configured to couple rod ends of the lift cylinders to a hydraulic reservoir during extension and retraction of the lift cylinders and to block flow from the rod ends when the cylinders are not being retracted.

5. The harvester of claim 1, wherein the left lift cylinder is coupled to a lower left front portion of the feeder house and the right lift cylinder is coupled to a lower right front portion of the feeder house.

6. The harvester of claim 5, wherein the rod ends of the cylinders are coupled to the feeder house and hydraulic fluid flow out of the rod ends is blocked during normal harvesting operation or machine transport.
